(19) United States
(12) Patent Application Publication
(10) Pub. No.: US 2009/0224567 A1
(43) Pub. Date: Sep. 10, 2009

(54) BAGGAGE COMPARTMENT STRUCTURE OF VEHICLE

(75) Inventors: Isao TOHDA, Hiroshima (JP); Kenji ASADA, Hiroshima (JP); Shigeyuki MORI, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/361,152

(22) Filed: Jan. 28, 2009

(30) Foreign Application Priority Data
Mar. 7, 2008 (JP) 2008-057430
Mar. 7, 2008 (JP) 2008-057469
Mar. 7, 2008 (JP) 2008-057502

(51) Int. Cl. B62D 25/10

(52) U.S. Cl. 296/76

(57) ABSTRACT

A trunk lid is provided so as to rotate around a front end portion thereof in such a manner that its back face in an open state faces substantially upward, and there is provided a support mechanism to support the trunk lid in the open state. Accordingly, there can be provided a baggage compartment structure of a vehicle which comprises a trunk room which is provided at a rear portion of a vehicle body so that an opening formed at an upper face thereof can be closed with the trunk lid, which can properly load various types of large-sized baggage without having the large and complex structure and damaging the vehicle design improperly.

### BACKGROUND OF THE INVENTION

The present invention relates to a baggage compartment structure of a vehicle, which comprises a trunk room which is provided at a rear portion of a vehicle body so that an opening formed at an upper face thereof is configured to be closed with a trunk lid.

For example, a sedan type of vehicle or a sports car type of vehicle have the trunk room which is provided at the rear portion of the vehicle body so that the opening formed at the upper face thereof can be closed with the trunk lid. In these types of vehicle, there is a case in which the size of the trunk room (volume, length, width, depth, etc.) may not be made large enough to store a large-sized baggage from a design or vehicle size perspective, for example. Meanwhile, the utility function of loading the large-sized baggage, such as a bicycle, has been recently demanded to even these types of vehicle for leisure or the like.

Japanese Patent Laid-Open Publication No. 11-245735, for example, discloses a baggage loading structure of the above-described type of vehicle, in which there are provided a pair of right and left rails and a support member for these rails are provided from a vehicle roof to an upper portion of a vehicle-body rear portion so as to load a bicycle as a large-sized baggage. Herein, a truck may be prepared so as to move on the rails by holding the bicycle on it, so that the bicycle can be properly loaded on the vehicle roof.

According to the baggage loading structure disclosed in the above-described patent publication, the truck may be necessary in addition to providing the rails provided from the vehicle roof to the upper portion of the vehicle-body rear portion, so the structure would become rather large and complex. Further, the truck may be designed only for the bicycle, so that another truck may be necessary for loading another kind of baggage.

Further, while the above-described patent document contains the description that the rails may be provided detachably, since the structure is rather large and complex as described above, attachment or detachment of the rails may require a considerably long time. Thus, the rails may be considered as parts which are substantially attached all the time. Therefore, the vehicle design may be damaged improperly.

Other baggage loading strictures which are similar to the above-described structure are also disclosed in Japanese Patent Laid-Open Publication Nos. 07-215136 and 2003-137035.

### SUMMARY OF THE INVENTION

An object of the present invention is to provide a baggage compartment structure of a vehicle which comprises a trunk room which is provided at a rear portion of a vehicle body so that an opening formed at an upper face thereof is configured to be closed with a trunk lid, which can properly load various types of large-sized baggage without having the large and complex structure and damaging the vehicle design improperly.

According to the present invention, there is provided a baggage compartment structure of a vehicle, which comprises a trunk room which is provided at a rear portion of a vehicle body so that an opening formed at an upper face thereof is configured to be closed with a trunk lid, wherein the trunk lid is provided so as to rotate around a front end portion thereof in such a manner that a back face thereof in an open state faces substantially upward and there is provided a support means operative to support the trunk lid in the open state.

According to the above-described present invention, by rotating the trunk lid around its front end portion in such a manner that the back face of the trunk lid in the open state faces substantially upward and by supporting the trunk lid, the baggage can be loaded by using the space inside and above the trunk room. For example, a baggage with the height which is greater than the depth of the trunk room or a baggage, such as a plant, having an upper portion with the longitudinal width which is greater than the opening of the trunk room can be loaded properly. Further, if a baggage fixing means, which will be described below, is used, a baggage like the bicycle can be loaded by using the space above the trunk lid and the opening of the trunk room. That is, the various types of large-sized baggage can be properly loaded without having the large and complex structure and damaging the vehicle design improperly. Further, since the trunk lid is supported by the support means in its open state, the trunk lid can be properly prevented from fluttering due to the vehicle vibration and thereby any improper influence to the vehicle body may be prevented.

According to an embodiment of the present invention, a baggage fixing means operative to fix a baggage in such a manner that a space above the trunk lid which is positioned in a specified open state and the opening of the trunk room is used as a loading space of the baggage fixed is fixedly or detachably provided at a specified position which enables the baggage fixing means to be located inside the trunk room when the opening of the trunk room is closed with the trunk lid. Thereby, since the baggage fixing means is provided so as to fix the baggage in such a manner that the space above the trunk lid and the opening of the trunk room is used as the loading space of the baggage fixed, the large-scaled baggage like the bicycle or a surfboard can be loaded by using the space above the trunk lid and the opening of the trunk room. Herein, since the baggage fixing means is fixedly or detachably provided at the specified position which enables the baggage fixing means to be located inside the trunk room when the opening of the trunk room is closed with the trunk lid, it is not viewed from the outside of the vehicle when the trunk lid is closed. Accordingly, the fine view of the vehicle may not deteriorate. Further, in a case in which the baggage fixing means is detachably provided, the space inside the trunk room can be properly used by removing the baggage fixing means when the trunk lid is closed. Also, various types of fixing means may be applied, and various types of baggage may be loaded accordingly.

According to another embodiment of the present invention, the vehicle is an open-top type of vehicle, in which an upper portion above a vehicle compartment which is formed in front of the trunk room is configured to be opened, and the support means is configured to support the trunk lid in such a manner that an upper end of the trunk lid in the open state is positioned at a specified level which is higher than an upper end of a passenger with a specified size who is seated at a specified location in the vehicle compartment. Thereby, even if any loaded article jumps out of the trunk room when the vehicle has a rear collision in a state in which the trunk lid is open, the trunk lid may protect the passenger of the vehicle from the article jumping out.

According to another embodiment of the present invention, the vehicle is an open-top type of vehicle, in which an upper portion above a vehicle compartment which is formed in front of the trunk room is configured to be opened, and the trunk lid in the open state is configured to constitute an aero-board operative to restrain a traveling wind (air) from flowing into a vehicle compartment. Thereby, the traveling wind (air) can be properly prevented from flowing into the vehicle compartment.

According to another embodiment of the present invention, the vehicle is an open-top type of vehicle, in which an upper portion above a vehicle compartment which is formed in front of the trunk room is configured to be opened, a roll bar is provided between the vehicle compartment and the trunk lid, and an interference-preventing portion operative to prevent interference of the trunk lid in the open state with the roll bar is provided at the trunk lid. Thereby, the trunk lid can be properly opened to its open state without any interference with the roll bar.

According to another embodiment of the present invention, a storage portion of the trunk room is comprised of a watertight storage-container member with water-resisting qualities. Thereby, even if the vehicle travels with the trunk lid open when it rains, the rain can stay properly in the storage-container member. Accordingly, the inside of the trunk room or panels which form the inner face of the vehicle body can be properly protected from the rainwater.

According to another embodiment of the present invention, a drain member to drain a liquid staying in the storage-container member is provided at the storage-container member. Thereby, the rainwater or the like which stay in the storage-container member can be drained easily. Herein, if the storage-container member is provided detachably to the trunk room, the liquid staying in it can be drained outside the trunk room.

According to another embodiment of the present invention, the storage-container member is so deep that a bottom thereof is located close to a lower face portion of the vehicle body. Thereby, the tall baggage can be stored stably without its projecting upward improperly.

According to another embodiment of the present invention, a lid to partition an inside space of the storage-container member into an upper side and a bottom side is provided at the storage-container member. Thereby, any thing which requires its privacy may be stored in the space of the bottom side of the storage-container member below the lid, so that the thing can be prevented from being viewed from the outside by the lid even when the trunk lid is open, thereby protecting the privacy of the thing. Further, articles stored in the space of the bottom side of the storage-container member can be prevented from being scattered in the air while the vehicle travels with the trunk lid open.

According to another embodiment of the present invention, a space to store a baggage therein is provided at a front portion of the storage-container member, and a lid to partition the space from an inside space of the storage-container member is provided at the storage-container member. Thereby, any thing which requires its privacy may be stored in the space at the front portion of the storage-container member, so that the thing can be prevented from being viewed from the outside by the lid even when the trunk lid is open, thereby protecting the privacy of the thing. Further, articles stored in the space at the front portion of the storage-container member can be prevented from being scattered in the air while the vehicle travels with the trunk lid open.

According to another embodiment of the present invention, at the storage-container member is provided a deformation promoting means operative to promote deformation of the storage-container member substantially in a longitudinal direction of the vehicle body when a specified load is applied to the storage-container member substantially in the longitudinal direction of the vehicle body. Thereby, it can be properly restrained that the impact load is applied to the vehicle compartment which is provided in front of the trunk room at the vehicle rear collision or the like. Accordingly, the safety of the passenger in the vehicle compartment can be improved.

According to another embodiment of the present invention, the storage-container member is made from resin. Thereby, the control of the above-described specified load can be easily conducted by adjusting the thickness or the like of the resin member.

According to another embodiment of the present invention, the deformation promoting means is configured to deform in a bellows shape in the longitudinal direction of the vehicle body when the specified load is applied to the storage-container member substantially in the longitudinal direction of the vehicle body. Thereby, the impact load can be absorbed effectively. Accordingly, it can be properly restrained that the impact load is applied to the vehicle compartment. Further, the control of the specified load can be easily conducted by adjusting the number of bellows, the depth of bellows and the like.

Herein, the storage-container member stores various things in it, so its inside may become dirty easily. Accordingly, it may be preferable that the member be removed easily for its cleaning. Therefore, the storage-container member may be possibly configured to be merely inserted into the recess portion of the vehicle body from above, without using bolts or the like. In this case, however, there is a concern that the storage-container member would be removed out of the vehicle improperly when the impact load is applied to the vehicle body at the state of the trunk lid open.

According to another embodiment of the present invention, the storage-container member is inserted into a recess portion which is provided at the vehicle body from above, engagement portions which engage with each other are provided at the storage-container member and the vehicle body, and at the storage-container member is provided an engagement releasing means operative to release an engagement of the engagement portions with a manual operation. Thereby, since the engagement portions which engage with each other are provided at the storage-container member and the vehicle body, it can be properly prevented that the storage-container member is removed out of the vehicle when the impact load is applied to the vehicle body. Further, since the engagement releasing means operative to release the engagement of the engagement portions with the manual operation is provided at the storage-container member, the storage-container can be easily removed out of the vehicle body.

Other features, aspects, and advantages of the present invention will become apparent from the following description which refers to the accompanying drawings.

### BRIEF DESCRIPTION OF THE DRAWINGS

FIG. 1A is a plan view and FIG. 1B is a side view of a vehicle with a baggage compartment structure according to a first embodiment of the present invention.

FIG. 2 is a view (an enlarged view of a roll bar portion), when viewed in a direction of an arrow A of FIG. 1A.

FIGS. 3A and 3B are views of the vehicle with a trunk lid open, which correspond to FIGS. 1A and 1B respectively.

FIG. 4 is an enlarged sectional view (enlarged view of a hinge portion) taken along line B-B of FIG. 1A.

FIG. 5A is an enlarged sectional view (enlarged view of a trunk-lid-side member portion of a lock mechanism) taken along line C-C of FIG. 1A, FIG. 5B is a sectional view taken along line D-D of FIG. 5A.

FIG. 6A is an enlarged view of a portion indicated by an arrow E of FIG. 2 (enlarged view of a vehicle-body-side member portion of the lock mechanism), when viewed from the vehicle, FIG. 6B is a sectional view taken along line F-F of FIG. 6A.

FIG. 7 is an enlarged sectional view (enlarged view of a lock-mechanism portion) taken along line G-G of FIG. 3A.

FIG. 8 is an enlarged sectional view (enlarged view of a trunk-room portion) taken along line II-II of FIG. 3A.

FIG. 9 is a perspective view of a storage-container member.

FIG. 10 is an example of baggage loading (case of a box).

FIG. 11 is another example of baggage loading (case of a plant).

FIG. 12 is another example of baggage loading (case of a bicycle).

FIGS. 13A and 13B are perspective views of an attachment for fixing the bicycle.

FIG. 14A is an enlarged sectional view (enlarged view of an attachment portion of an attachment to the trunk lid and an attachment portion of an automotive vehicle to the attachment) taken along line J-J of FIG. 12, and FIG. 14B is an enlarged sectional view (enlarged view of an attachment portion of the attachment to a rear wall of the trunk room and the attachment portion of the automotive vehicle to the attachment) taken along line K-K of FIG. 12.

FIG. 15 is another example of baggage loading (case of a surfboard).

FIG. 16 is a perspective view of an attachment for fixing the surfboard.

FIG. 17A is a plan view and FIG. 17B is a side view of the vehicle with a baggage compartment structure according to a second embodiment of the present invention.

FIGS. 18A and 18B are views of the vehicle with the trunk lid open, which correspond to FIGS. 17A and 17B respectively.

FIG. 19 is an enlarged sectional view (enlarged view of a hinge portion) taken along line L-L of FIG. 17A.

FIG. 20A is an enlarged sectional view (enlarged view of a trunk-lid-side member portion of the lock mechanism) taken along line M-M of FIG. 17A, and FIG. 20B is an enlarged sectional view (enlarged view of a vehicle-body-side member portion of the lock mechanism) taken along line N-N of FIG. 17A.

FIG. 21 is an enlarged sectional view (enlarged view of a lock-mechanism portion) taken along line P-P of FIG. 18A.

FIG. 22 is a side view of the vehicle with a baggage compartment structure according to a third embodiment of the present invention.

FIG. 23A is a plan view and FIG. 23B is a side view of the vehicle with a baggage compartment structure according to a fourth embodiment of the present invention.

FIG. 24 is an enlarged sectional view (enlarged view of an aero-board portion) taken along line Q-Q of FIG. 23A.

FIG. 25 is an enlarged sectional view (enlarged view of the aero-board portion) taken along line R-R of FIG. 23A.

FIG. 26A is a plan view and FIG. 26B is a side view of the vehicle with a baggage compartment structure according to a fifth embodiment of the present invention.

FIG. 27 is an enlarged sectional view of a trunk-room portion of a baggage compartment structure according to a sixth embodiment of the present invention.

FIG. 28 is a perspective view of a storage-container member of the present embodiment.

FIG. 29 is an enlarged sectional view taken along line L-L of FIG. 27.

FIG. 30 is an operation diagram when an impact load is applied from the vehicle rear.

FIG. 31 is an enlarged view of a portion indicated by an arrow M of FIG. 27.

FIG. 32 is a view of a baggage compartment structure according to a seventh embodiment of the present invention, which corresponds to FIG. 8.

FIG. 33 is a perspective view of a storage-container member of the seventh embodiment.

FIG. 34 is a view of a baggage compartment structure according to an eighth embodiment of the present invention, which corresponds to FIG. 8.

FIG. 35 is a perspective view of a storage-container member of the eighth embodiment.

FIG. 36 is a perspective view of a storage-container member of a ninth embodiment.

FIG. 37 is another example of baggage loading of the ninth embodiment (case of a bicycle).

FIG. 38 is an enlarged sectional view taken along line M-M of FIG. 37.

### DETAILED DESCRIPTION OF THE INVENTION

Hereinafter, the baggage compartment structure of a vehicle according to preferred embodiments of the present invention will be described.

### Embodiment 1

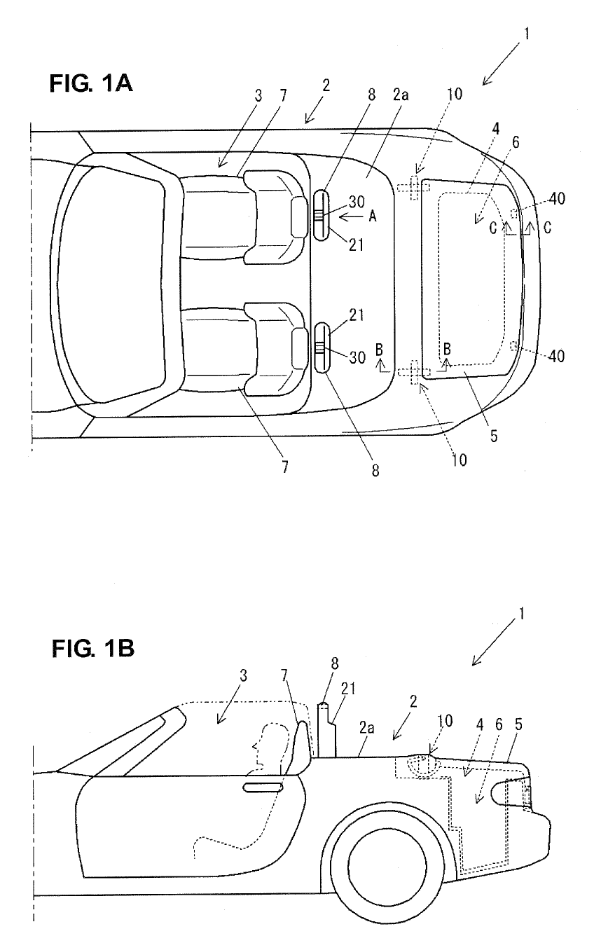

The baggage compartment structure according to the present embodiment is applied to a vehicle 1 shown in FIGS. 1A, 1B. This vehicle 1 is an open-top type of vehicle in which a vehicle compartment 3 is provided at the central portion in the longitudinal direction of a vehicle body 2 and an upper portion above the vehicle compartment 3 can be opened.

A trunk room 6 is provided at the rear side of the vehicle body 2 of the vehicle 1, specifically at a rear side of a portion between a rear end of the vehicle compartment 2 and a rear end of the vehicle body 2. An opening 4 formed at an upper face of the trunk room 6 can be closed with a trunk lid 5.

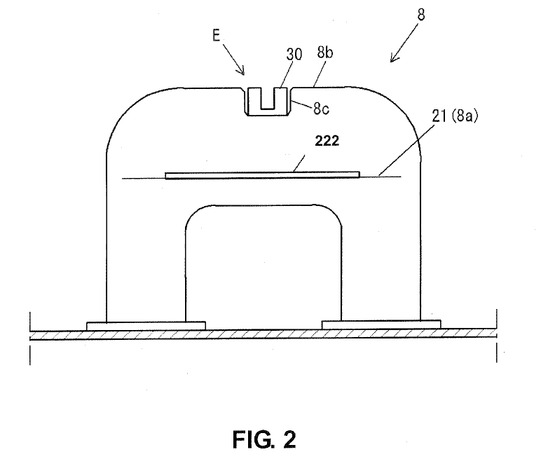

Further, the vehicle 1, which is the open-top type of vehicle as described above, is equipped with roll bars 8, 8 which are respectively provided, behind right and left seats 7, 7, on an upper face 2a of the vehicle body 2 between the vehicle compartment 3 and the trunk lid 5. The roll bar 8 is to protect a passenger in case of the vehicle rolling over, which has a gate shape as shown in FIG. 2 (a view, when viewed in a direction of an arrow A of FIG. 1A).

The trunk lid 5 is supported at the vehicle body 2 via a pair of binges 10, 10 which is provided at both ends of a front end portion of the lid 5 as shown in FIGS. 1A and 1B. According to the present embodiment, the trunk lid 5 is configured to rotate around its front end by the hinges 10, 10 in such a manner that its back face in its open state faces substantially upward.

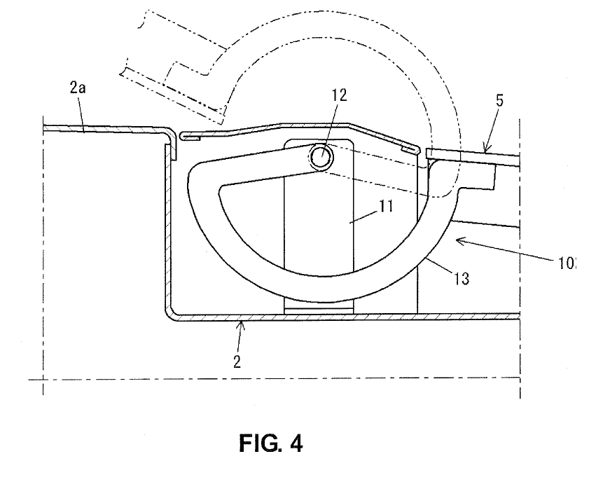

The hinge 10 comprises, as shown in FIG. 4, a support bracket 11 which is fixed to the vehicle body 2 and a swan-neck type of rotational arm 13 which is rotatably supported via a support axis 12 which is provided at an upper end portion of the support bracket 11. The support axis 12 is positioned substantially at the same level as the upper face of the trunk lid 5, so that the lid 5 can rotate in such a manner that the back face of the lid 5 faces substantially upward without interfering the vehicle-body upper face 2a behind the vehicle compartment 3 as shown by broken lines.

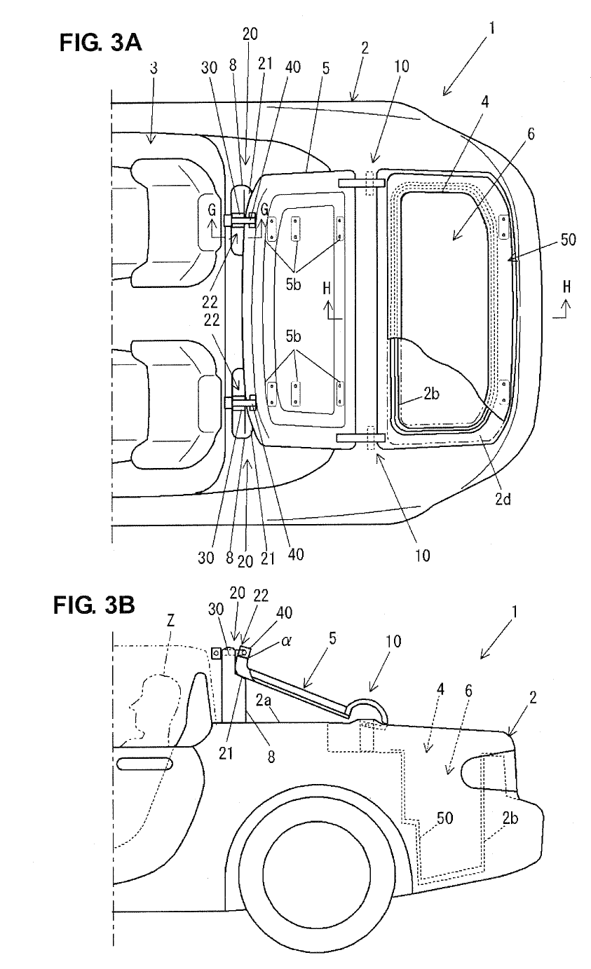

Further, a support mechanism 20 to support the trunk lid 5 in the open state (FIGS. 3A, 3B) is provided in the present embodiment.

The support mechanism 20 comprises, as shown in FIGS. 3A and 3B, a support portion 21 which is provided at the roll bar 8 so as to support the rear end portion of the trunk lid 5 and a lock mechanism 22 which locks the trunk lid 5 in its open state.

Herein, the support portion 21 is, as shown in FIG. 2, comprised of a difference-in-level portion 8a which is provided at the back face of an upper portion of an upper side portion 8b of the roll bar 8, and a resilient member 222 to protect a deign face of the rear end portion of the trunk lid 5 is attached to the upper face of the difference-in-level 8a.

Herein, as apparent from FIG. 3B, the height of the support portion 21 is set such that an upper end α of the trunk lid 5 is higher than an upper end of a passenger Z with a specified size who is seated in a seat 7 (at a specified location) in the vehicle compartment 3.

The lock mechanism 22 comprises, as shown in FIGS. 1A, 1B, 3A, 3B, a roll-bar-side member 30 which is provided at the roll bar 8 and a lid-side member 40 which is provided at the rear portion of the trunk lid 5.

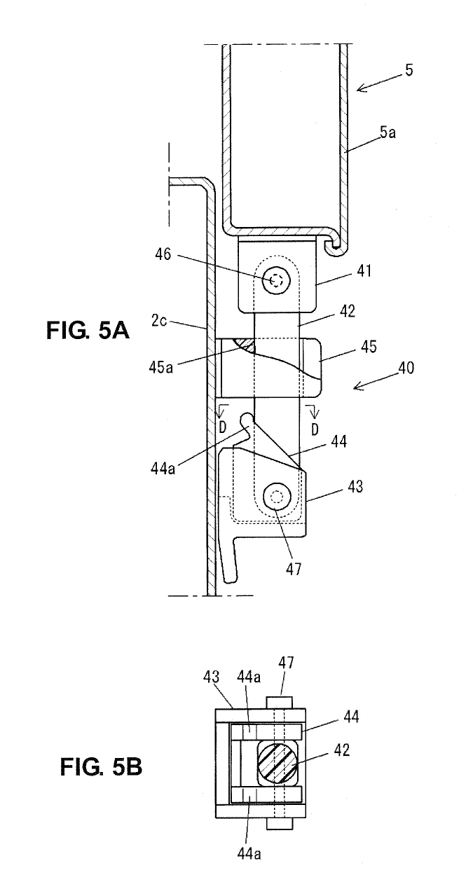

The lid-side member 40 comprises, as shown in FIGS. 5A and 5B, a support bracket 41 which is fixed to a lower face portion of the rear wall 5a of the trunk lid 5, a bar member 42 which is rotatably supported at one end thereof so as to rotate around an axis 46 which is supported at the support bracket 41 so as to extend in the vehicle width direction, and an operational member 43 and an engagement member 44 which are supported so as to rotate around an axis 47 provided at the other end portion of the bar member 42. The bar member 42 is configured to engage with a groove 45a of an engaging member 45 which is attached to the outer face of a trunk-room rear wall 2c of the vehicle body 2 when the lock mechanism 22 is not used.

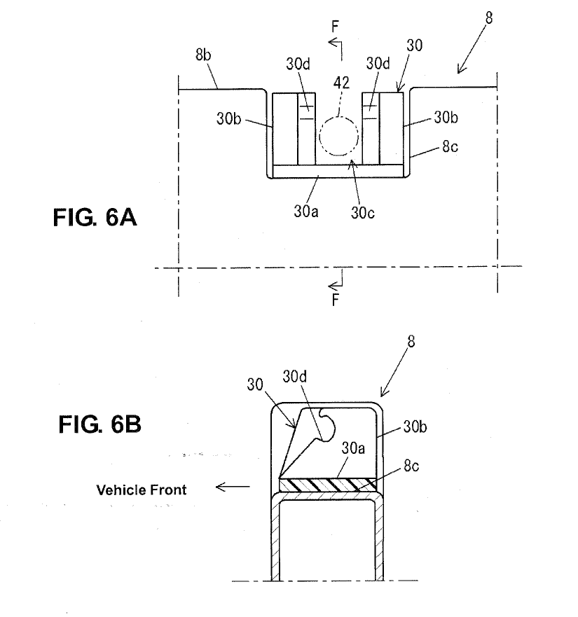

Meanwhile, the roll-bar-side member 30 is, as shown in FIG. 2, attached in a recess portion 8c which is formed at the center of the upper portion of the upper side portion 8b of the roll bar 8. The roll-bar-side member 30 comprises, as shown in FIG. 6, a base portion 30a and a pair of vertical wall portions 30b, 30b which extend upward from right and left end portions of the base portion 30a. These portions 30a, 30b, 30b form a groove portion 30c which the bar member 42 of the lid-side member 40 can engage with.

As shown in FIGS. 5A, 5B, 6A, 6B, engagement recess portions 30d, 30d and engagement projection portions 44a, 44a, which are configured to engage with each other, are provided at the front portion side of the inner face of the vertical wall portions 30b, 30b of the roll-bar-side member 30 and the upper portion side (in the vertical direction in FIGS. 5A, 5B) of the engagement member 44 of the lid-side member 40.

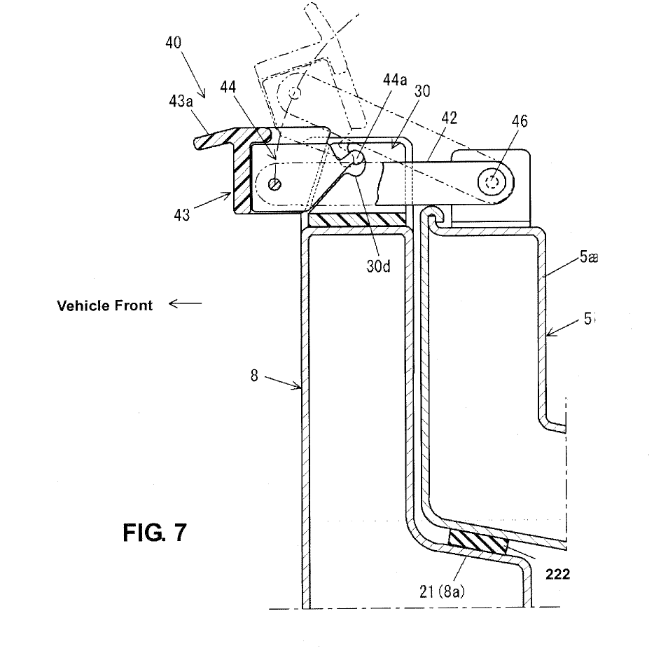

As shown in FIG. 7, in a state in which the rear end portion of the trunk lid 5 in the open state is placed on the support portion 21 of the roll bar 8 via the resilient member 222, the bar member 42 is rotated around the axis 46 by holding an operational portion 43a of the operational member 43, so that the engagement between the recess portion 30d and the projection portion 44a is achieved as shown by broken lines. Then, the bar member 42 is further rotated around the axis 46 with the rotation of the operational member 43 and the engagement member 44 around this engagement portion, so that the engagement recess portion 30d of the engagement member 30 and the engagement projection portion 44a of the engagement member 44 are made in the engagement state shown by solid lines. In this engagement state, the locked state is maintained until the operation of the operational member 43 by the toggle mechanism. That is, even if the vehicle I travels with the trunk lid 5 open as shown in FIGS. 3A, 3B, the trunk lid 5 can be properly prevented from fluttering due to the vehicle vibration or the like, and thereby any improper influence to the vehicle body can be prevented.

Thus, according to the present embodiment, even the large baggage, which may not be loaded with the trunk lid 5 in the closed state, can be loaded with the trunk lid 5 which is open by using the space above the opening 4 of the trunk room 6. And, the vehicle 1 can travel in this state. Further, this advantage can be achieved without the large and complex structure and damaging the vehicle design.

Herein, since the rainwater comes into the trunk room 6 if the vehicle 1 travels with the trunk lid 5 open when it rains, it may be preferable that some proper measures to this be taken.

According to the present embodiment, as shown in FIGS. 3A, 3B, the trunk room is comprised of a recess portion 2b which is formed by panels of the vehicle body 2 and a watertight storage-container member 50 (storage portion) which is made from resin, which is inserted into the recess portion 2b from above.

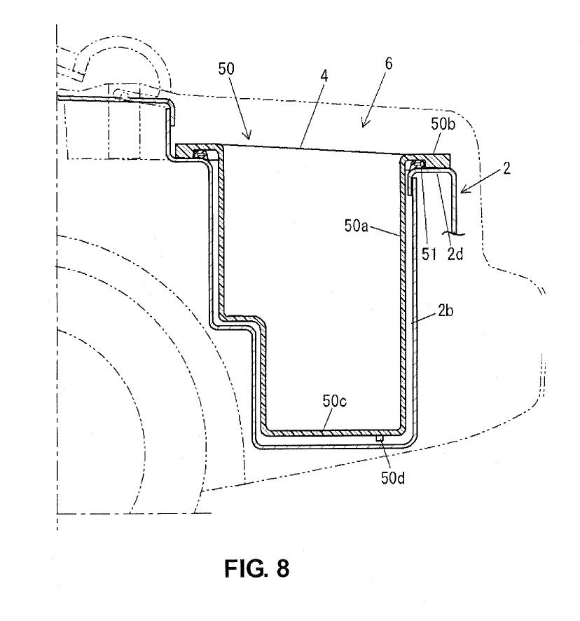

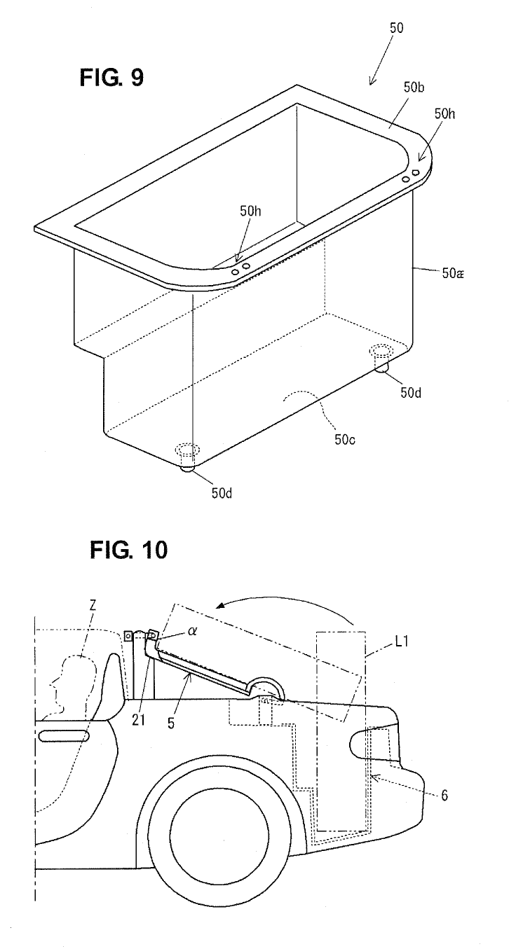

The storage-container member 50 comprises, as shown in FIGS. 8 and 9, a box portion 50a which is of a box shape and has an open upper face (forming the opening 4) and a flange portion 50b which is provided at an upper edge of the body portion 50a. The storage-container member 50 is supported at the vehicle body 2 with the flange portion 50b being placed on a flat-face portion 2d which is provided along the upper end portion of the recess portion 2b of the vehicle body. Accordingly, the storage-container member 50 can be removed of the recess portion 2b by being pulled up.

A seal member 51 is attached to the lower face of the flange portion 50b so as to prevent the rainwater or the like from coming into the recess portion 2b and some portion of the vehicle body 2 which is continuous to the recess portion 2b. Thus, according to the present embodiment, since the storage-container member 50 is provided, the inside of the recess portion 2b of the trunk room 6 or panels which form the vehicle body can be properly protected from the rainwater.

Further, at a bottom-face portion 50c of the storage-container member 50 are provided drains 50d, 50d with caps, not illustrated. In a case in which the vehicle travels with the trunk lid 5 in the open state in the rain and the rainwater stays in the storage-container member 50, the rainwater can be drained by removing the caps after taking out the storage-container member 50. Also, when the storage-container member 50 becomes dirty, it can be easily cleaned with the water or the like after being removed from the vehicle body 2. Further, the storage-container member 50 is so deep that its bottom is located close to the lower face portion of the vehicle body. Accordingly, even a tall baggage can be stored in it properly and stably.

Hereinafter, some examples of the baggage loading will be described.

FIG. 10 shows an example in which a tall baggage L1 which is greater than the depth of the trunk room 6. Thus, according to the baggage compartment structure of the present embodiment, even the tall baggage which is greater than the depth of the trunk room 6 can be properly loaded.

In this case, since the upper end a of the trunk lid 5 in the open state is positioned at the specified level which is higher than the upper end of the passenger Z with the specified size who is seated at the specified location in the vehicle compartment 3, even if the baggage L1 jumps out of the trunk room 6 when the vehicle has a rear collision, the trunk lid can protect the passenger of the vehicle from the baggage L1 jumping out.

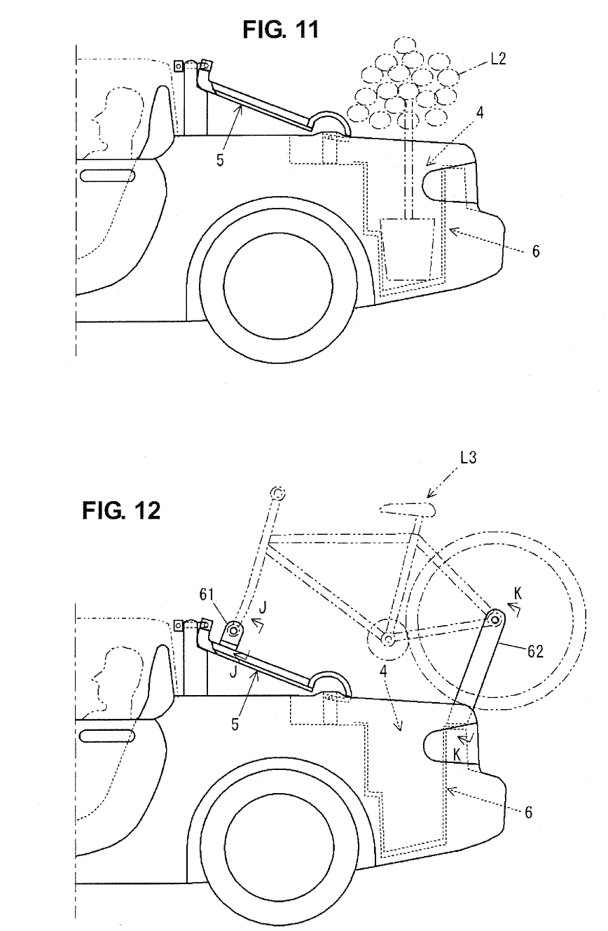

FIG. 11 is another example in which a baggage L2, such as a plant, having an upper portion with the longitudinal width which is greater than the opening 4 of the trunk room 6. Thus, according to the baggage compartment structure of the present embodiment, even the baggage with the longitudinal width which is greater than the opening 4 can be properly loaded.

In the present embodiment, as shown in FIGS. 3A and 3B, there are provided plural attachment portions 5b . . . 5b operative to attach an attachment, which will be described later, at the back face (an inner panel, for example) of the trunk lid 5. Herein, by fixing this attachment to the attachment portions 5b . . . 5b when the trunk lid 5 is in the open state, the space above the trunk lid 5 and the opening 4 of the trunk room 6 can be used as the baggage-loading space.

For example, FIG. 12 is another example in which a bicycle L3 is loaded at the space above the trunk lid 5 and the opening 4 of the trunk room 6 by using support brackets 61, 62 as an attachment 60.

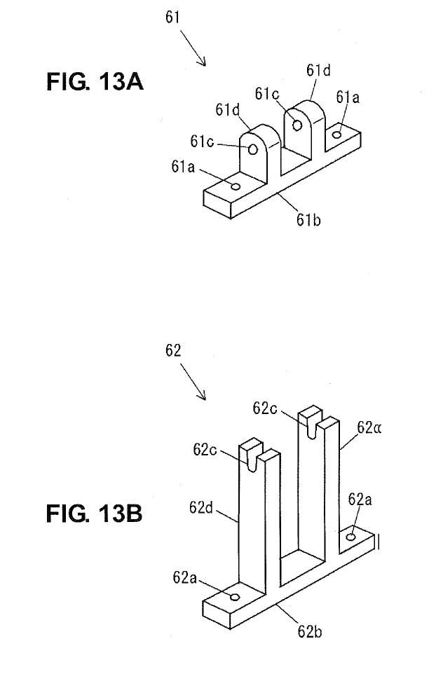

The front support bracket 61 comprises a base portion 61b which has a pair of bolt holes 61a, 61a, and a pair of standing portions 61d, 61d which is provided so as to stand from the base portion 61b and has bolt holes 61c, 61c at the upper end portion thereof, as shown in FIG. 13A.

Meanwhile, the rear support bracket 62 comprises a base portion 62b which has a pair of bolt holes 62a, 62a, and a pair of standing portions 62d, 62d which is provided so as to stand from the base portion 62b and has bolt holes 62c, 62c at the upper end portion thereof, as shown in FIG. 13B.

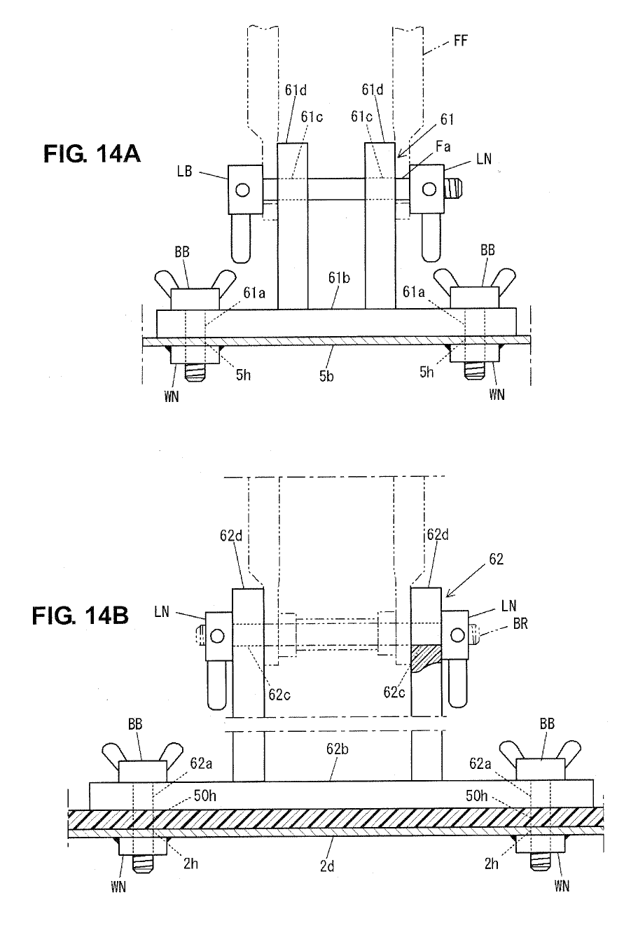

Herein, the front support bracket 61 is fixed, as shown in FIG. 14A, by applying bolts BB into nuts WN provided at the inner face of the attachment portion 5b at the back face of the trunk lid 5 through the bolt holes 61a, 61a of the base portion 61b and bolt holes 5h, 5h which are formed at the attachment portion 5b at the back face of the trunk lid 5. Further, a bolt with an handle LB is inserted into front-wheel journal portions Fa (a groove portion and a hole portion) of a lower end portion of a front fork FF of a bicycle and the bolt holes 61c of the standing portion 61d of the front support bracket 61. Then, by applying a pair of nuts with handles LN to the tips of the bolt LB, the front-wheel journal portions Fa are fixed to the front support bracket 61.

Meanwhile, the rear support bracket 62 is fixed, as shown in FIG. 14B, by applying bolts BB into nuts WN provided at the lower face of the flat-face portion 2d of the upper edge of the recess portion 2b of the vehicle body 2 through the bolt holes 62a, 62a of the base portion 62b and bolt holes 50h, 50h of the flange portion 50b of the storage-container member 50 and bolt holes 2h, 2h formed at the flat-face portion 2d. Further, by placing the both ends of a rear-wheel axle bolt BR of the bicycle L3 into the grooves 62c of the standing portions 62d, 62d from above and by applying the nuts with handles LN to the both ends of the bolt BR, the rear side portion of the bicycle is fixed to the rear support bracket 62.

Thus, by fixing the front portion and the rear portion of the bicycle L3 to the trunk lid 5 and the vehicle body 2 via the attachments 61, 62, the space above the trunk lid 5 and the opening 4 of the trunk room 6 can be used as the loading space of the bicycle L3.

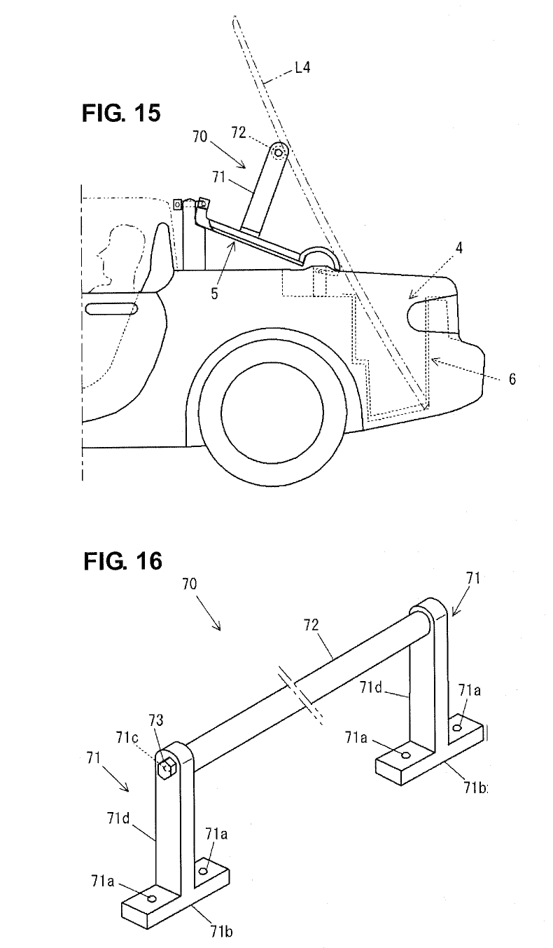

FIG. 15 shows another example in which a surfboard L4 is loaded in the space above the trunk lid 5 and the opening 4 of the trunk room 6.

An attachment 70 for this is comprised of a pair of brackets 71, 71 and a pole member 72 as shown in FIG. 16. The support brackets 71, 71 comprise base portions 71b, 71b which have a pair of bolt holes 71a, 71a respectively and a pair of standing portions 71d, 71d which is provided so as to stand from the base portions 71b, 71b and has bolt holes 71c, 71c at the upper end portions thereof respectively.

The pole member 72 is screwed to the upper ends of the support brackets 71, 71 with bolts 73, 73 through screw holes 71c, 71c. That is, the pole member 72 can be disassembled. The base portions 71b, 71b of the both support brackets 71, 71 are fixed to the attachment portions 5b, 5b of the back face of the trunk lid 5 with screws like the support bracket 61.

Then, as shown in FIG. 15, the lower portion of the surfboard L4 is stored in the trunk room 6, and its upper portion is fixed to the pole member 72 of the attachment 70 with a string or the like. Thus, the space above the trunk lid 5 and the opening 4 of the trunk room 6 is used as the loading space for the surfboard L4.

Herein, other long baggage than the surfboard L4, such as a wash-line pole, bow, plate, can be properly loaded by the attachment 70.

Thus, according to the present embodiment, since the attachments 60, 70 are detachable to the trunk lid 5 or the vehicle body 2, the space inside the trunk room 6 can be effectively used by removing the attachments 60, 70 when the trunk lid 5 is closed. Further, various kinds of attachment may be used, so various kinds of baggage can be loaded accordingly.

Since the attachments 60, 70 are fixedly or detachably provided at the specified position (attachment portion or the like) which enables the attachments 60, 70 to be located inside the trunk room 6 when the trunk lid 5 is closed, they are not viewed from the outside of the vehicle 1 when the trunk lid 5 is closed. Accordingly, the fine view of the vehicle 1 may not deteriorate.

Herein, if the baggage fixing means is relatively small, it may be provided at the specified position which enables it to be located inside the trunk room 6 so as to be integral with the back face of the trunk lid 5, the storage-container member 50, or the like. In this case, the operation of attaching or removing the attachment can be properly omitted.

While the attachment 60 for loading bicycle and the attachment 70 for loading surfboard or the like are described in the above-described embodiment, other various kinds of baggage may be loaded by applying attachments for other kids of baggage. Further, while the application to the open-top type of vehicle is described in the present embodiment, the present invention is applicable to another type, such as a sedan type, of vehicle.

### Embodiment 2

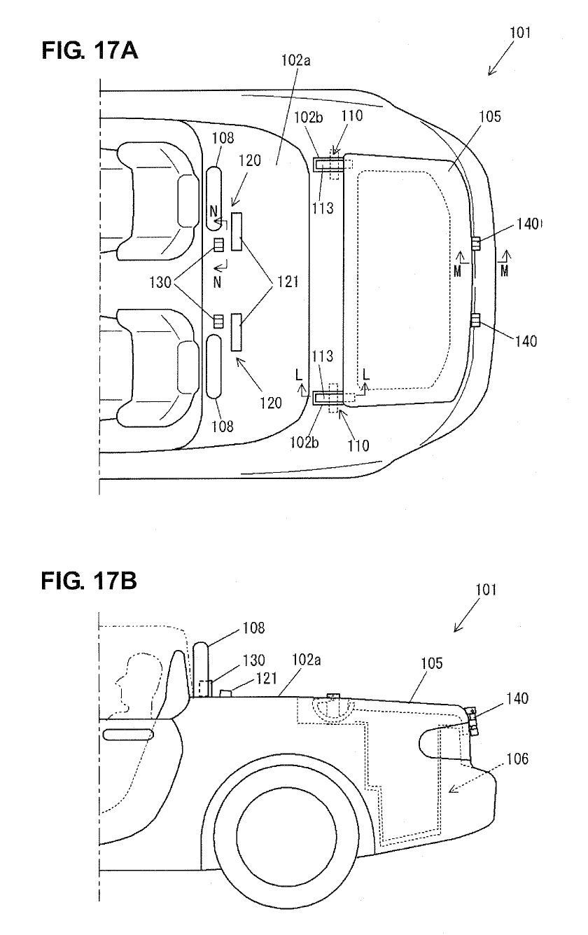

A second embodiment of the present invention will be described referring to FIGS. 17A, 17B-21.

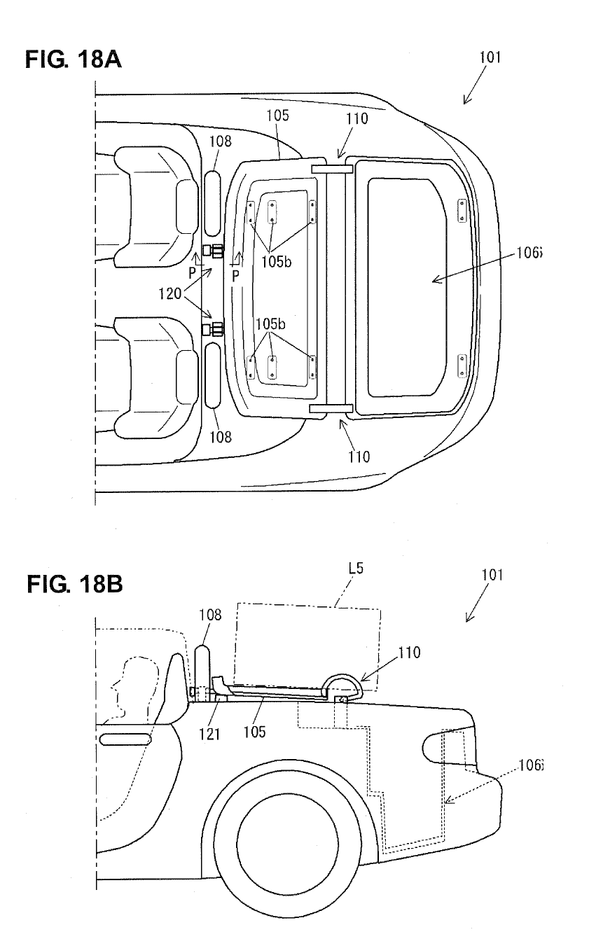

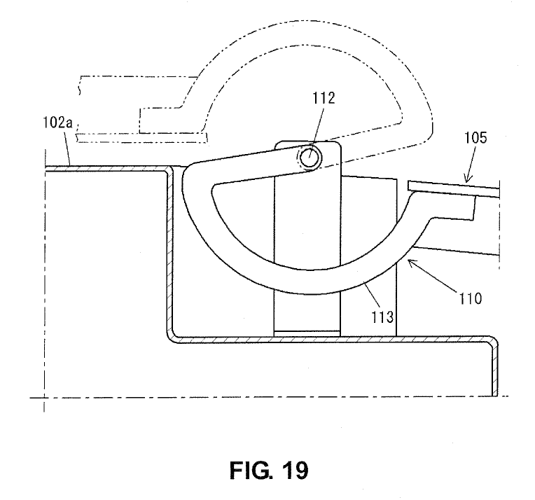

A vehicle 101 of the second embodiment is configured such that a trunk lid 105 is opened to a substantially horizontal state as shown in FIG. 18A, 18B. That is, as shown in FIG. 19, a hinge 110, which is the swan-neck type like the first embodiment, is configured such that a support axis 112 is positioned at a higher level than the upper face of the trunk lid 105 and an upper face 102a of a vehicle body 102, thereby enabling the trunk lid 105 to open substantially horizontally, without any interference with the upper face 102a of the vehicle body 102, as shown by broken lines.

Returning to FIGS. 17A, 17B, the longitudinal position of the hinge 110 and the longitudinal length of the trunk lid 105 are set so as not to interfere with roll bars 108 even if the trunk lid 105 opens substantially horizontally. Further, at the upper face 102a of the vehicle body 102 is formed a pair of notches 102b which extends in the vehicle longitudinal direction to avoid interference with a pair of rotational arms 113. Further, as shown in FIGS. 17A, 17B, a pair of support mechanisms 120 comprises a pair of support members 121 which is provided at the vehicle-body upper face behind the roll bars 108 and made of a resilient member, and a pair of lock mechanisms 122.

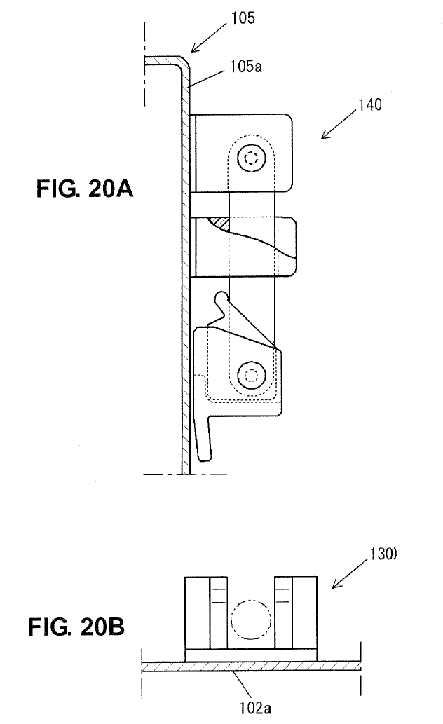

The lock mechanism 122 has a similar structure to the first embodiment, but has a different disposition position. As shown in FIGS. 17A, 17B, 20A, 20B, lid-side members 140 are provided at the rear face of a rear wall 105 of the lid 105, and vehicle-body-side members 130 are attached to the vehicle-body upper face 120a beside the roll bars 108. The basic structures of the members 130, 140 are substantially the same as those of the first embodiment, so their descriptions are omitted here.

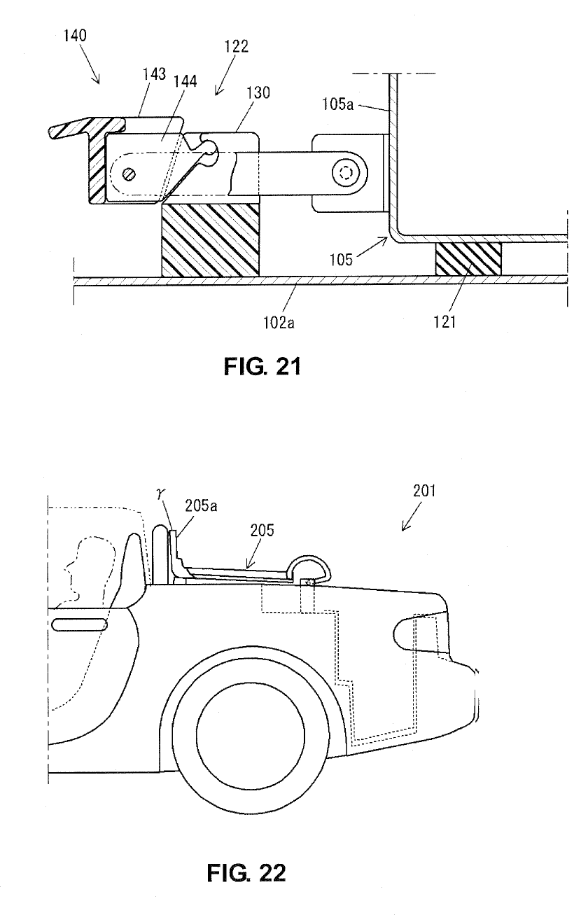

As shown in FIG. 21, the rear portion of the trunk lid 105 is supported by the support member 121 in the sate in which the trunk lid 105 is open. Then, by making engagement between an engagement member 144 and the vehicle-body-side member 130 with operation of an operational member 143 of the lock mechanism 122, the trunk lid 105 is locked in its open state. Other structures are similar to the first embodiment, and their descriptions are omitted here.

According to the above-described structure, as shown in FIGS. 18A, 18B, any baggage L5 which needs to be loaded substantially or any baggage which may not be stored inside the trunk room 106 can be properly loaded on the back face of the trunk lid 105. In this case, the baggage L5 may be fixed properly with a string whose hook is detachably provided at an attachment portion 105b at the back face of the lid 105. Herein, the string engaging portion may be formed integrally with the back face of the trunk lid 105.

Herein, in a case in which the attachment is used, the one having the suitable length to the present embodiment may be prepared properly.

In general, the traveling wind (air) tends to flow into the vehicle compartment in case of the open-top type of vehicle. Hereafter, other embodiments (third and fourth embodiments) equipped with measures for preventing the traveling wind from flowing in will be described.

### Embodiment 3

At first, a third embodiment will be described referring to FIG. 22. A vehicle 201 according to the third embodiment is configured such that the vertical length of a rear wall 205a of the trunk lid 205 is longer than that of the second embodiment. This vertical length is set such that an upper end position γ (upper end in FIG. 22) of a rear wall 205a of a trunk lid 205 in the open state is positioned at a specified level which is equivalent to or higher than the upper end position of the passenger, for example.

According to the present embodiment, the rear wall 205a of the trunk lid 205 can be made perform the aero-board function, merely by setting the vertical length of the rear wall 205a as described above.

### Embodiment 4

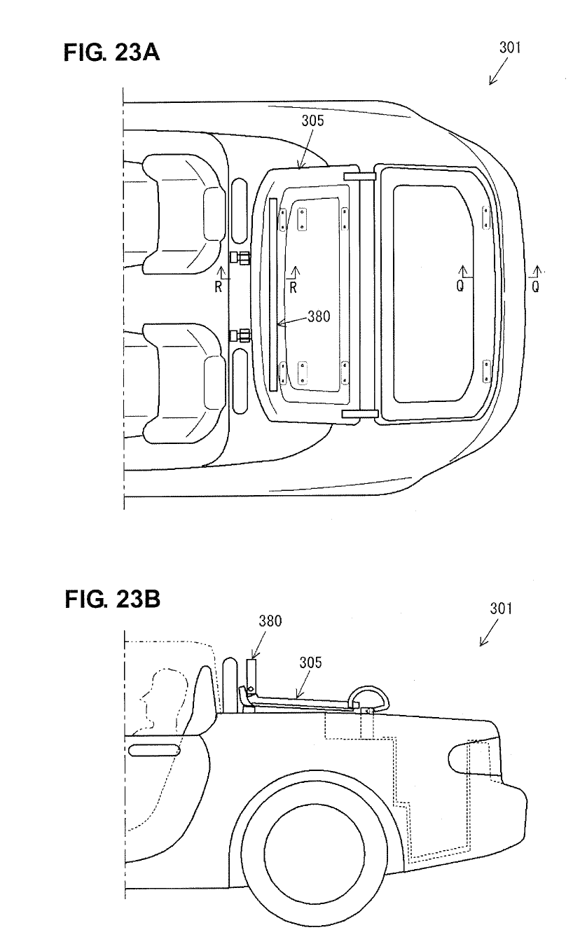

A fourth embodiment will be described referring to FIGS. 23A, 23B. A vehicle 301 of the fourth embodiment has an aero-board member 380 at a rear portion of the back face of a trunk lid 305.

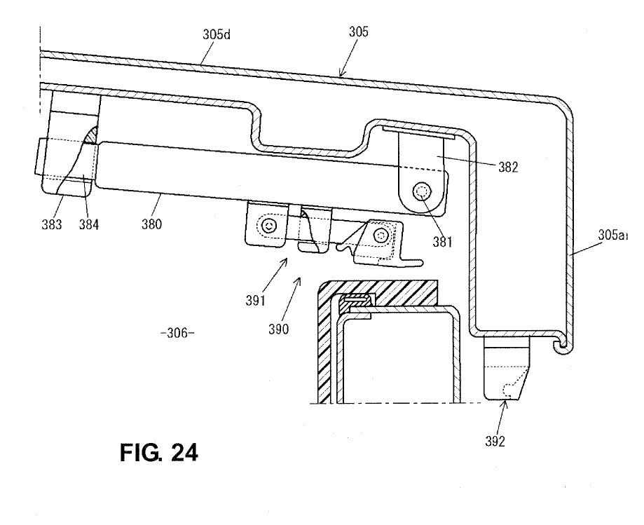

The aero-board member 380 is stored in a trunk room 306 so as to be located along the back face of an upper face portion 305d of the trunk lid 305 in the closed state of the trunk lid 305 as shown in FIG. 24. Its rear end portion (in FIG. 24) is supported at a support axis 381 and a support bracket 382, which are provided at the back face of the upper face portion 305d of the trunk lid 305, so that the aero-board member 380 can rotate longitudinally. An engagement member 384 provided at its front end portion (in FIG. 24) engages with an engagement member 383 provided at the back face of the upper face portion 305d of the trunk lid 305.

Further, as shown in FIG. 24, an aero-board lock mechanism 390 which has a boar-side member 391 and a lid-side member 392 like the above-described lock mechanism is provided at the lower face of the aero-board member 380 and the lower face of a rear wall 305a of the trunk lid 305.

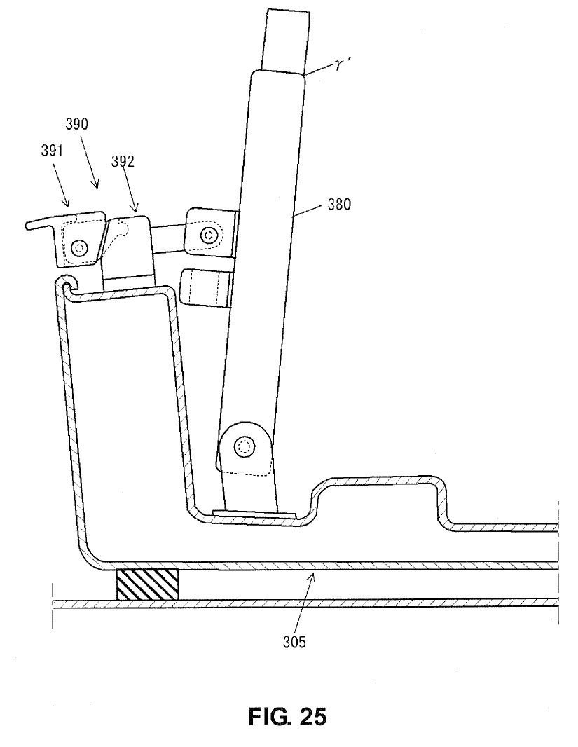

Then, in the open state of the trunk lid 305 shown in FIG. 25, the aero-board member 380 is made stand up and herein the board-side member 391 and the lid-side member 392 of the aero-board lock mechanism 390 are made engage with each other. Thereby, the aero-board member 380 can be held in its standing state. The shape of the aero-board member 380 is preferably configured such that the level of its upper end γ′ is equivalent to or higher than the upper end portion of the passenger in the standing state.

According to the present embodiment, the function of the aero-board can be achieved by the aero-board member 380 provided at the trunk lid 305 even in a case in which the shape of the rear wall 305a of the trunk lid 305 may not be changed like the above-described third embodiment for the reason of design, for example. Further, since the aero-board member 380 can be properly located inside the vehicle body, the proper vehicle design can be maintained.

Herein, while the aero-board member 380 is supported at the back face of the trunk lid 305 so as to rotate according to the present embodiment, a bracket to fix the aero-board member to the attachment portion of the back face of the trunk lid may be provided at the aero-board member and the bracket may be fixed via bolts or the like. Thereby, the stricture may be simple without lock mechanism.

### Embodiment 5

While the roll bar is provided near the seat in the vehicle compartment in the above-described first-fourth embodiments, there may be a case in which it is disposed rearward for the design reason or the like. In this case, however, there is a concern that the front end portion of the trunk lid interferes with the roll bar when the trunk lid opens so that the back face of the trunk lid faces substantially upward. Therefore, a fifth embodiment which solves this concern will be described.

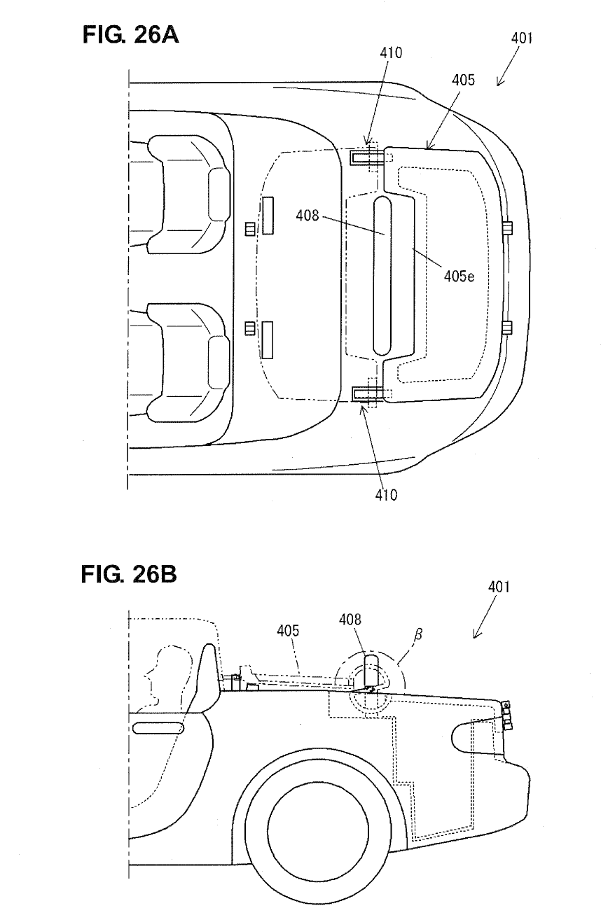

That is, a vehicle 401 according to the fifth embodiment is configured, as shown in FIGS. 26A, 26B, such that a roll bar 408 is disposed almost at the same longitudinal position as hinges 410 and a notch 405e is formed at the front end portion of the trunk lid 405.

The width of the notch 405e is greater than that of the roll bar 408, and its depth (longitudinal length) is set so that the move locus β of the front end of the notch 405e can extends passing over the upper end of the roll bar 408. Accordingly, when the trunk lid 405 is opened to the state in which its back face faces substantially upward, it can be prevented that the trunk lid 405 interferes with the roll bar 408.

### Embodiment 6

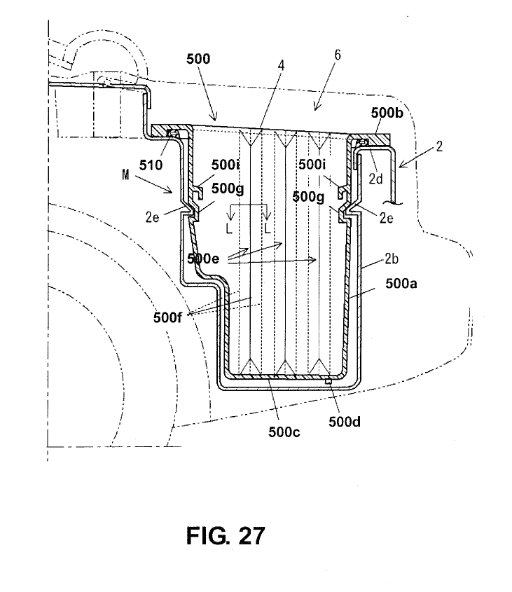

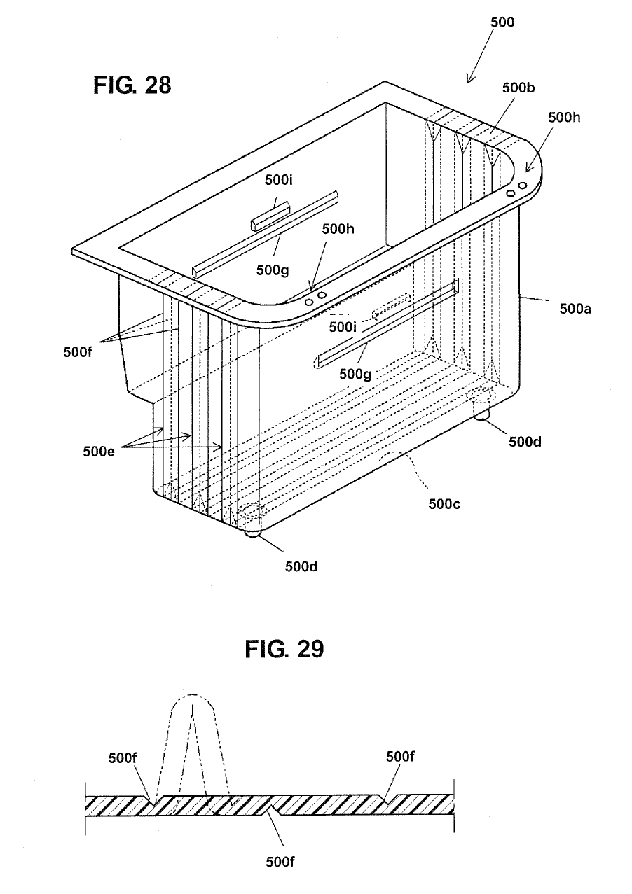

A storage-container member 500 of the present embodiment comprises, as shown in FIGS. 27 and 28, a box portion 500a which is of a box shape and has an open upper face (forming the opening 4) and a flange portion 500b which is provided at an upper edge of the body portion 500a. The storage-container member 500 is supported at the vehicle body 2 with the flange portion 500b being placed on the flat-face portion 2d which is provided along the upper end portion of the recess portion 2b of the vehicle body. Accordingly, the storage-container member 500 can be removed of the recess portion 2b by being pulled up.

A seal member 510 is attached to the lower face of the flange portion 500b so as to prevent the rainwater or the like from coming into the recess portion 2b and some portion of the vehicle body 2 which is continuous to the recess portion 2b. Thus, according to the present embodiment, since the storage-container member 500 is provided, the inside of the recess portion 2b of the trunk room 6 or panels which form the vehicle body 2 can be properly protected from the rainwater.

Further, at a bottom-face portion 500c of the storage-container member 500 are provided drains 500d, 500d with caps, not illustrated. In a case in which the vehicle travels with the trunk lid 5 in the open state in the rain and the rainwater stays in the storage-container member 500, the rainwater can be drained by removing the caps after taking out the storage-container member 500. Also, when the storage-container member 500 becomes dirty, it can be easily cleaned with the water or the like after being removed from the vehicle body 2. Further, the storage-container member 500 is so deep that its bottom is located close to the lower face portion of the vehicle body. Accordingly, even the tall baggage can be stored in it properly and stably.

Herein, in the present embodiment, as shown in FIGS. 27 and 28, the storage-container member 500 has a plurality of folding portions 500e . . . 500e (deformation promoting means) which are properly collapsible in the longitudinal direction when the impact load is applied to the vehicle body 2 from the vehicle rear.

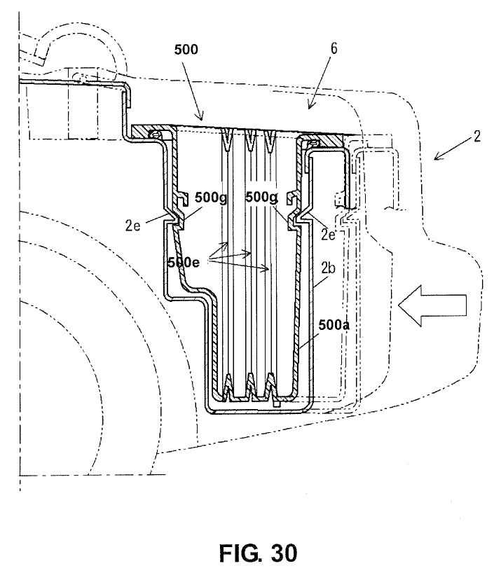

The folding portions 500e . . . 500e are comprised of plural grove portions 500f . . . 500f which are formed at both-side face portions and the bottom-face portion of the body portion 500a, and the flange portion 500b. The groove portions 500e . . . 500e are comprised of V-shaped grooves as shown in FIG. 29. When the impact load which is greater than a specified value is applied to the storage-container member 500 from the vehicle rear, the respective groove portions 500f . . . 500f bend, so that the storage-container member 500 is deformed so as to fold longitudinally in a bellows shape as shown in FIG. 30.

Accordingly, it can be properly restrained that the impact load is applied to the vehicle compartment 3 which is located in front of the trunk room 6 at the vehicle rear collision or the like. Thereby, the safety of the passenger in the vehicle compartment 3 can be improved. Further, since the storage-container member 500 is made of resin, the control of the above-described value of the impact load can be easily conducted by adjusting the thickness or the like of the resin member.

Further, since the folding portions 500e . . . 500e (deformation promoting means) are configured so as to fold in the longitudinal direction of the vehicle body in the bellows shape when the impact load which is greater than the specified value is applied to the storage-container member 500, the impact load can be effectively absorbed. Accordingly, it can be properly prevented that the impact load is applied to the vehicle compartment 3. Further, the control of the specified value of the impact load can be easily conducted by adjusting the number of bellows, the depth of bellows and the like.

Herein, the storage-container member 500 stores various things in it, so its inside may become dirty easily. Accordingly, it may be preferable that the member 500 be removed easily to be cleaned up. Therefore, the storage-container member 500 is configured to be merely inserted into the recess portion of the vehicle body from above, without using bolts or the like. In this case, however, there is a concern that the storage-container member 500 would be removed out of the vehicle improperly when the impact load is applied to the vehicle body 2 at the state of the trunk lid 5 open.

According to the present embodiment, as shown in FIGS. 27 and 28, at the front face portion and the rear face portion of the body portion 500a of the storage-container member 500 are respectively formed recess portions 500g, 500g (engagement portions) which extend in the vehicle width direction and project toward the container inside. Further, at the front face portion and the rear face portion of the recess portion 2b of the vehicle body are respectively formed projection portions 2e, 2e (engagement portions) which extend in the vehicle width direction and project toward the storage-container member 500. The projection portions 2e, 2e are formed at the position which corresponds to the recess portions 500g, 500g of the storage-container member 500 stored in the recess portion 2b, so that the recess portions 500g, 500g of the storage-container member 500 and the projection portions 2e, 2e of the vehicle body 2 engage with each other in the application state.

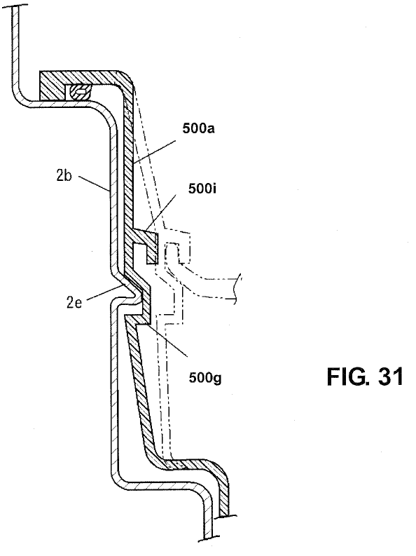

Further, handling portions 500i, 500i which project toward the inside of the member 500 at the front face portion and the rear face portion of the base portion 500a of the storage-container member 500 above the above-described recess portions 500g, 500g. Further, the storage-container member 500 is configured as shown in FIG. 31 such that the front face portion and the rear face portion of the base portion 500a deform toward the center of the member 500 as shown by the broken lines when the handling portions 500i, 500i are pulled toward the center of the member 500 (for example, the thickness of these face portions are set to be deformable). Thereby, the engagement between the projection portion 2e of the vehicle body 2 and the recess portion 500g of the storage-container member 500 is releasable with a manual operation.

As described above, since the projection portions 2e, 2e and the recess portions 500g, 500g (engagement portions) which engage with each other are provided at the base portion 500a of the storage-container member 500 and the recess portion 2b of the vehicle body 2 according to the present embodiment, the storage-container member 500 can be prevented from being removed out of the vehicle improperly even when the impact load is applied to the vehicle body 2. Also, since the handling portions 500i, 500i (engagement releasing means) operative to release the above-described engagement with the manual operation are provided at the storage-container member 500, the member 500 can be easily removed out of the vehicle body 2, for example, when it is cleaned up.

Herein, in place of the folding portions 500e . . . 500e, another type of bellows-shape portion which does not contract perfectly at the initial stage but contracts further when receiving the impact load may be applied. Further, by weakening the strength of the side face portion, bottom face portion or flange portion of the body portion 500a compared with the strength of its front face portion and rear face portion, the deformation promoting means may be provided.

### Embodiment 7

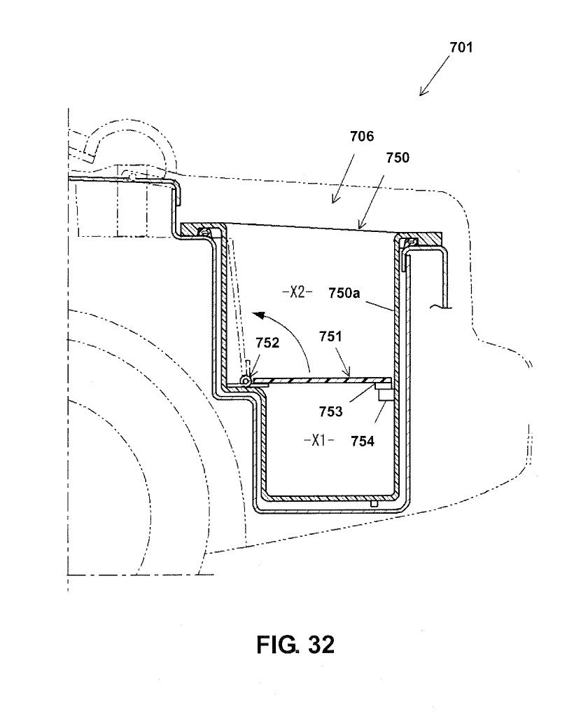

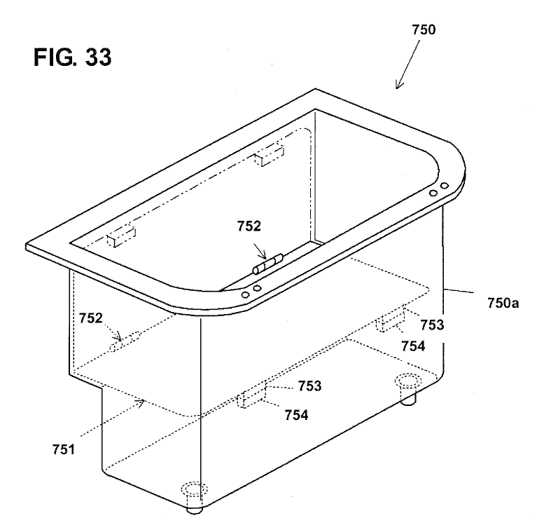

A seventh embodiment will be described referring to FIGS. 32 and 33. In a vehicle 701 of the seventh embodiment, as shown in FIGS. 32 and 33, at a storage-container member 750 which forms the storage portion of a trunk room 706 is provided a lid 751 which partitions an inside space of the member 750 into an upper-portion-side space X2 and a bottom-portion-side space X1. The lid 751 is supported at a front wall portion of a body portion 750a so as to rotate around its front end portion via a hinge 752. Further, a lid-side engagement member 753 and a storage-container-member-side engagement member 754 which engage with each other are provided at a rear end portion of the lid 751 and a rear wall portion of the body portion 750a of the storage-container member 750. Thereby, the lid 751 is configured to be held substantially horizontally and locked.

According to the seventh embodiment, any thing which requires its privacy may be stored in the space X1 of the bottom side, so that the thing can be prevented from being viewed from the outside by the lid 751 even when the trunk lid 751 is open, thereby protecting the privacy of the thing. Further, articles stored in the space X1 can be prevented from being scattered in the air while the vehicle travels with the trunk lid 751 open.

### Embodiment 8

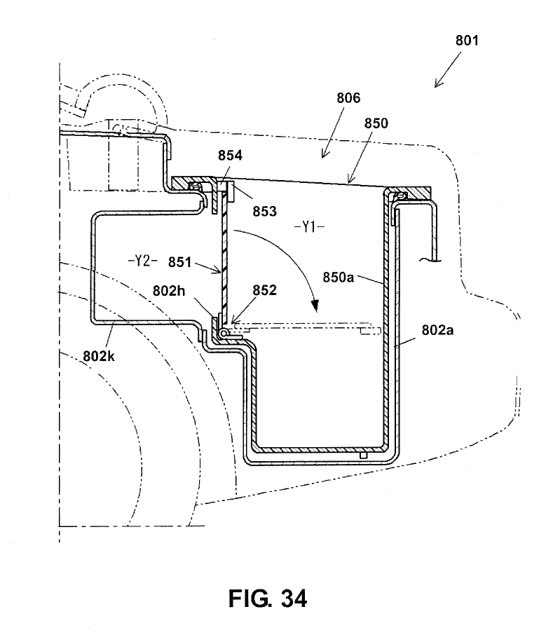

An eighth embodiment will be described. In a vehicle 801 of the eighth embodiment, as shown in FIG. 34, an opening 802h is formed at a front wall portion of a recess portion 802a of a trunk room 806, and a boxy member 802k which opens rearward is provided in front of the opening 802h, so that a space Y2 is formed in front of a baggage-storage space Y1 of the storage-container member 850.

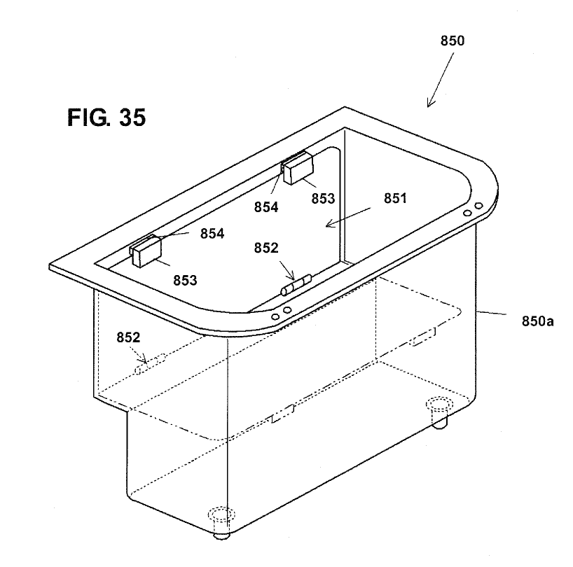

Further, as shown in FIGS. 34 and 35, at the storage-container member 850 is provided a lid 851 which partitions the front space Y2 from the inside space Y1 of the storage-container member 850. The lid 851 is supported at a lower edge portion of the opening 802h of the front wall portion of the body portion 850a of the storage-container member 850 via a hinge 852 at its lower end portion so at to rotate. Further, a lid-side engagement member 853 and a storage-container-member-side engagement member 854 which engage with each other are provided at a rear end portion of the lid 851 and a rear wall portion of the body portion 850a of the storage-container member 850. Thereby, the lid 851 is configured to be held substantially horizontally and locked.

According to the eighth embodiment, any thing which requires its privacy may be stored in the front space Y2, so that the thing can be prevented from being viewed from the outside by the lid even when the trunk lid 851 is open, thereby protecting the privacy of the thing. Further, articles stored in the space Y2 can be prevented from being scattered in the air while the vehicle travels with the trunk lid 851 open.

### Embodiment 9

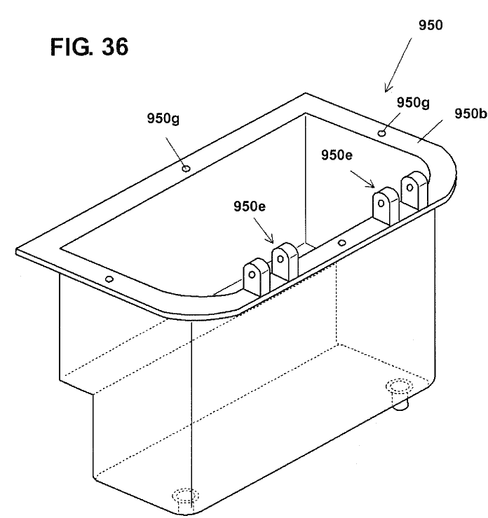

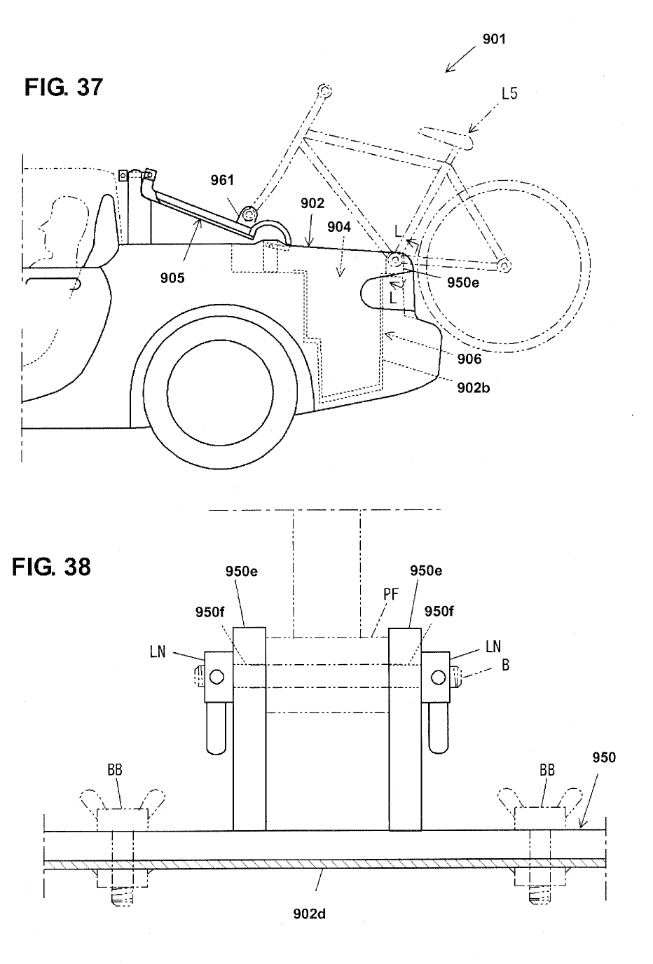

A ninth embodiment will be described referring to FIGS. 36 and 37. In a vehicle 901 of the ninth embodiment, as shown in FIG. 36, baggage fixing portions 950e, 950e are formed integrally at a rear side portion of a flange portion 950b of a storage-container member 950. At the baggage fixing portion 950e is formed a bolt hole 950f like the attachment 61 of the first embodiment. Further, at the flange portion 950 of the storage-container member 950 are formed holes 950g . . . 950g for bolt fixing to the vehicle body.

Further, as shown in FIG. 37, the bicycle L5 can be loaded with the baggage-fixing portions 950e and the attachment. Herein, in case of loading it, the flange portion 950b of the storage-container member 950 are fixed to a vehicle body 902 with bolts inserting into the holes 950 g . . . 950g, so that it can be prevented that the storage-container member 950 inclines or gets out of a recess portion 902b. Then, the front portion of the bicycle L5 is fixed to the back face of the trunk lid 905 with the attachment. This fixing may be properly achieved in the same manner as the first embodiment. Meanwhile, a pedal journal portion PF of the bicycle is fixed to the baggage-fixing portions 950e of the storage-container member 950. Specifically, as shown in FIG. 37, by inserting a bolt B into the bolt holes 950f of the baggage-fixing portions 950e and the pedal journal portion PF of the bicycle L5 and applying nuts with handle LN, LN, the bicycle L5 is fixed to thee baggage-fixing portions 950e.

According to the ninth embodiment, the similar advantages to the first embodiment can be provided, reducing the number of attachments prepared. Further, the operation of attaching or removing the attachment can be properly omitted.

The present invention should not be limited to the above-described embodiments, and any other modifications and improvements may be applied in the scope of a spirit of the present invention.

What is claimed is:

1. A baggage compartment structure of a vehicle, which comprises a trunk room which is provided at a rear portion of a vehicle body so that an opening formed at an upper face thereof is configured to be closed with a trunk lid, wherein said trunk lid is provided so as to rotate around a front end portion thereof in such a manner that a back face thereof in an open state faces substantially upward and there is provided a support means operative to support the trunk lid in the open state.

2. The baggage compartment structure of a vehicle of claim 1, wherein a baggage fixing means operative to fix a baggage in such a manner that a space above said trunk lid which is positioned in a specified open state and said opening of the trunk room is used as a loading space of the baggage fixed is fixedly or detachably provided at a specified position which enables the baggage fixing means to be located inside the trunk room when the opening of the trunk room is closed with the trunk lid.

3. The baggage compartment structure of a vehicle of claim 1, wherein the vehicle is an open-top type of vehicle, in which an upper portion above a vehicle compartment which is formed in front of the trunk room is configured to be opened, and said support means is configured to support the trunk lid in such a manner that an upper end of the trunk lid in the open state is positioned at a specified level which is higher than an upper end of a passenger with a specified size who is seated at a specified location in the vehicle compartment.

4. The baggage compartment structure of a vehicle of claim 1, wherein the vehicle is an open-top type of vehicle, in which an upper portion above a vehicle compartment which is formed in front of the trunk room is configured to be opened, and the trunk lid in the open state is configured to constitute an aero-board operative to restrain a traveling wind from flowing into a vehicle compartment.

5. The baggage compartment structure of a vehicle of claim 1, wherein the vehicle is an open-top type of vehicle, in which an upper portion above a vehicle compartment which is formed in front of the trunk room is configured to be opened, a roll bar is provided between the vehicle compartment and the trunk lid, and an interference-preventing portion operative to prevent interference of the trunk lid in the open state with the roll bar is provided at the trunk lid.

6. The baggage compartment structure of a vehicle of claim 1, wherein a storage portion of the trunk room is comprised of a watertight storage-container member with water-resisting qualities.

7. The baggage compartment structure of a vehicle of claim 6, wherein a drain member to drain a liquid staying in the storage-container member is provided at the storage-container member.

8. The baggage compartment structure of a vehicle of claim 6, wherein said storage-container member is so deep that a bottom thereof is located close to a lower face portion of the vehicle body.

9. The baggage compartment structure of a vehicle of claim 6, wherein a lid to partition an inside space of the storage-container member into an upper side and a bottom side is provided at the storage-container member.

10. The baggage compartment structure of a vehicle of claim 6, wherein a space to store a baggage therein is provided at a front portion of the storage-container member, and a lid to partition said space from an inside space of the storage-container member is provided at the storage-container member.

11. The baggage compartment structure of a vehicle of claim 6, wherein at said storage-container member is provided a deformation promoting means operative to promote deformation of the storage-container member substantially in a longitudinal direction of the vehicle body when a specified load is applied to the storage-container member substantially in the longitudinal direction of the vehicle body.

12. The baggage compartment structure of a vehicle of claim 11, wherein said storage-container member is made from resin.

13. The baggage compartment structure of a vehicle of claim 11, wherein said deformation promoting means is configured to deform in a bellows shape in the longitudinal direction of the vehicle body when the specified load is applied to the storage-container member substantially in the longitudinal direction of the vehicle body.

14. The baggage compartment structure of a vehicle of claim 11, wherein said storage-container member is inserted into a recess portion which is provided at the vehicle body from above, engagement portions which engage with each other are provided at the storage-container member and the vehicle body, and at the storage-container member is provided an engagement releasing means operative to release an engagement of said engagement portions with a manual operation.

15. The baggage compartment structure of a vehicle of claim 1, wherein at said storage-container member is provided a deformation promoting means operative to promote deformation of the storage-container member substantially in a longitudinal direction of the vehicle body when a specified load is applied to the storage-container member substantially in the longitudinal direction of the vehicle body.

16. The baggage compartment structure of a vehicle of claim 15, wherein said storage-container member is made from resin.

17. The baggage compartment structure of a vehicle of claim 15, wherein said deformation promoting means is configured to deform in a bellows shape in the longitudinal direction of the vehicle body when the specified load is applied to the storage-container member substantially in the longitudinal direction of the vehicle body.

18. The baggage compartment structure of a vehicle of claim 15, wherein said storage-container member is inserted into a recess portion which is provided at the vehicle body from above, engagement portions which engage with each other are provided at the storage-container member and the vehicle body, and at the storage-container member is provided an engagement releasing means operative to release an engagement of said engagement portions with a manual operation.
